(19) United States
(12) Patent Application Publication
(10) Pub. No.: US 2008/0165695 A1
(43) Pub. Date: Jul. 10, 2008

(54) Estimation of Bandwidth Requirements in a Communications Network with Access Controls

(75) Inventors: Joachim Charzinski, Munchen (DE); Claus Gruber, Munchen (DE)

Correspondence Address: BELL, BOYD & LLOYD, LLP, P.O. BOX 1135, CHICAGO, IL, 60690, US

(73) Assignee: SIEMENS AKTIENGESELLSCHAFT, Munchen (DE)

(21) Appl. No.: 11/791,070

(22) PCT Filed: Oct. 27, 2005
(86) PCT No.: PCT/EP05/55602

§ 371 Date: May 18, 2007

(30) Foreign Application Priority Data
Nov. 18, 2004 (DE) 10 2004 055 722.5

(51) Int. Cl. H04L 12/66

(52) U.S. Cl. 370/252

(57) ABSTRACT

In one aspect, a method for estimating the bandwidth requirements for a transmission between an input node and an output node of a network with access controls is provided. According to the method, with respect to a time period, the sum of the value of the average bandwidth of the traffic that has been transmitted between the nodes during the time period and the weighted value of the accumulated bandwidth of the declined reservation requests is calculated. An efficient, approximate determination of the traffic matrix of the network and thus an optimal new definition of the limits for the access controls is permitted. This provides particular advantages in terms of efficiency and resources for applications in networks with a dynamic adaptation of the access controls to modified traffic situations.

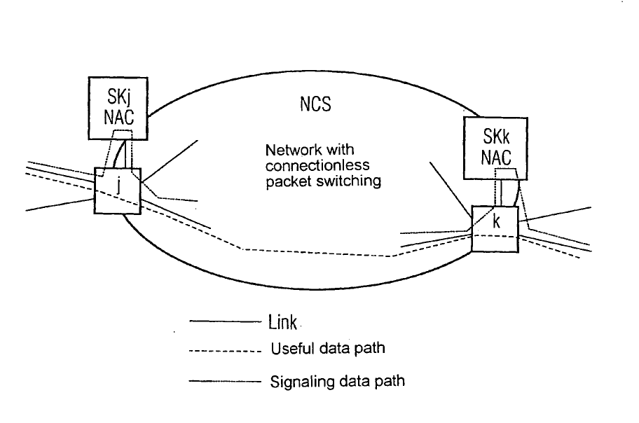

### CROSS REFERENCE TO RELATED APPLICATIONS

This application is the US National Stage of International Application No. PCT/EP2005/055602, filed Oct. 27, 2005 and claims the benefit thereof. The International Application claims the benefits of German application No. 102004055722.5 DE filed Nov. 18, 2004, both of the applications are incorporated by reference herein in their entirety.

### FIELD OF INVENTION

The invention relates to a method and a device for estimating the bandwidth requirements in a communications network, formed using nodes and links, with access controls.

### BACKGROUND OF INVENTION

One of the most important current trends in the field of networks is the further development of data networks for the transmission of real-time traffic which may contain voice information, video information and audio information. For services which require the transmission of real-time traffic, so-called quality of service parameters must be guaranteed.

The so-called IP networks which are based on the Internet Protocol (IP) are the most important example of a data network technology that is undergoing further development for the transmission of voice. Important parameters that need to be checked for the transmission of real-time traffic are for example the propagation time of the packets, the jitter and the loss rate. Particularly with regard to the criteria in respect of the propagation time, it is necessary to prevent overload situations occurring within networks. One important measure for the prevention of overload is to restrict the volume of traffic transmitted over the network. For this purpose, in many data networks having a real-time traffic capability an admission restriction or admission control is performed for traffic to be transmitted. With regard to networks which provide an admission control at the network entry point for traffic to be transmitted, this access control should as far as possible be implemented in such a manner that on the one hand a transmission with the required quality of service characteristics is possible but that on the other hand as little traffic as possible is declined or not transmitted.

### SUMMARY OF INVENTION

In order to optimize adaptation of limits for access control to a network it is necessary to know the volume of traffic to be carried. In traffic theory, the so-called traffic matrix is used for representing this information which contains the traffic volume to be carried between the individual nodes of a network as matrix entries. In this situation, it is not the traffic actually carried or transported that is represented but the traffic pending or presented for transportation, in other words the traffic which would be transported if there were no restriction on the bandwidth available in the network.

The object of the invention is to set down a procedure with which it is possible to estimate the bandwidth requirements in a communications network with access controls.

This object is achieved by the subject matter of the independent claims.

According to the invention, an estimated value is determined for the bandwidth requirements (the traffic offered, weighted with the announced bandwidth) for the traffic to be transmitted between an input node and an output node of the network. This estimated value is related to a time interval. In order to ascertain this estimated value two values are determined: A first value for the traffic volume or bandwidth permitted within the time interval for transportation between the two nodes, and a second value which corresponds to the accumulated bandwidth of the reservation requests declined during the time interval. For the first value, the average bandwidth reserved during the time interval for the transmission between the two nodes is used. The second value can be ascertained by registration of the reservation requests not permitted within the time interval or of the bandwidth requested with regard to these reservations. Such reservation requests are received for example by a control entity at the network border, which is then also responsible for the reservation. The control entity can then extract and sum the requested bandwidth in the case of declined reservation requests.

From the two values, an estimated value for the bandwidth requirements for traffic to be transmitted between the two nodes is then formed by adding the first value to the weighted second value. A weighting or normalization is necessary because the sum of the bandwidths of the declined reservation requests represents an upper limit for the actually additionally needed bandwidth requirements which becomes a more realistic estimate as a result of multiplication by a factor taking this fact into consideration. The number of reservation requests declined in the time interval can be used for this weighting or normalization. For example, it is possible to divide the second value by the number of reservation requests declined in the time interval (which would correspond to a normalization). An improvement can be achieved by introducing an interpolation parameter lying between zero and one, by which for example the number of reservation requests declined in the time interval is increased. By this means it is possible to take into account the retry of reservation requests. Alternatively or in addition, it is possible to explicitly take into account retries, for example by assessing successive declined reservation attempts within one time interval having the same source and the same destination as retries. Furthermore, it is possible to weight the value with the estimated holding time of the declined reservation, relative to the time interval of the measurement.

A further development of the method is given by the fact that estimated values are ascertained for two successive time intervals and interpolated. A so-called “exponentially weighted moving average” can thus be formed from the results of successive estimates. In this manner, allowance is made for the long-term development of bandwidth requirements and the latter is taken into consideration.

Alternatively or in addition, the measurement can instead take place in successive time intervals in a so-called “sliding window” or “jumping window”, whereby successive measurements are performed not in disjoint but in overlapping time intervals. An interpolation of the measurement values can thus be achieved by extending the time interval of the measurement.

In some networks, a nominal value is predefined for the bandwidth requirements. This nominal value can for example be a value set by the network operator or it corresponds to a long-term empirical value. Such a nominal value can be taken into consideration, for example by taking the maximum from nominal values and estimated value or interpolating both values.

The estimation of the bandwidth requirements can be performed by means of a device in the network. With regard to this device, it can for example be a normally central control server for the network. It is however likewise conceivable to provide for determination of the estimated values in parts of the management system of the network or in a service control facility. Determination of the estimated value can be performed both centrally and also decentrally. With regard to a decentralized determination, for specific node pairs in the network in each case for example, it is possible to provide means for calculating the estimated value in routers of the network or in access control units of the network (normally on the network border) that are responsible for access control. The invention is preferably implemented in one of the aforementioned devices by means of software or computer programs.

The invention permits an efficient and fast estimation of the bandwidth requirements. This bandwidth requirement is preferably ascertained for all pairs from input and output nodes of the network. From the values for the bandwidth requirements for the pairs from input and output nodes it is then possible, given a known traffic distribution (routing) within the network, to ascertain the expected link loads. The inventive estimation of the bandwidth requirements can be used particularly advantageously in the case of networks in which the limits for the access controls are modified dynamically, in other words a new determination of optimum limits takes place frequently on the basis of the respective current traffic matrix.

### BRIEF DESCRIPTION OF THE DRAWINGS

The object of invention will be described in detail in the following in the context of an embodiment with reference to a FIGURE.

The FIGURE shows a network with connectionless packet switching.

### DETAILED DESCRIPTION OF INVENTION

In this network, access controls are performed for QoS traffic. One pair from the input and output nodes is given by two routers j and k. Assigned to the nodes are signaling components SKj and SKk which also provide functions for access controls NAC (NAC: network admission control).

In a central network control server (NCS), an “active traffic matrix” is estimated on the basis of observations of the budget working loads in the NAC facilities. To this end, the following data is acquired at time intervals of length Δt for each border-to-border budget (in other words the bandwidth available for the transmission between the network borders or network nodes):
Yₐ(j,k) . . . average permitted bandwidth from node j to node k in time interval Δt
Yᵣ(j,k) . . . sum of the bandwidths of the declined reservation requests in time interval Δt
Nᵣ(j,k) . . . number of requests declined in time interval Δt

The permitted traffic Yₐ(j,k) will generally correspond to the bandwidth paid for. The factor governing the blocking (in other words the non-admission of traffic) is however the offered traffic from j to k, A(j,k). With regard to declined reservation requests, the expected average holding time ht is additionally required. Since it is not clear with regard to the declined reservation requests whether they represent retries or they are individual independent requests, A(j,k) will lie between Yₐ(j,k)+Yᵣ(j,k)*ht/Δt and Yₐ(j,k)+Yᵣ(j,k)*ht/Δt/Nᵣ(j,k). In the former case it is a question purely of independent requests and in the latter case purely of retries of the same request. A(j,k) is therefore estimated with the aid of an interpolation parameter βε[0,1]:

A(j,k)=Yₐ(j,k)+Yᵣ(j,k)*ht/Δt/(Nᵣ^{β})

An alternative interpolation for A(j,k), which is easier to calculate, is given by:

A(j,k)=Yₐ(j,k)+Yᵣ(j,k)*(1−β+β/Nᵣ)

A further possible way of taking a retry into consideration is to assess successive declined reservation attempts having the same source and the same destination within a time interval as retries. It is possible to modify this procedure by additionally using the request for the same bandwidth as an additional criterion for retries. A further embodiment consists in taking into consideration only the one of the retries with different bandwidths which has the greatest (smallest, mean, . . . ) bandwidth. This procedure is based on the consideration that unsuccessful reservation attempts are frequently retried whilst requesting a lower bandwidth.

The value A_{E}(j,k) to be used for the currently estimated traffic matrix is determined by means of an exponentially weighted moving average from the results of successive estimations (i−1, i):

A_{E}(j,k)⁽ⁱ⁾=αA(j,k)⁽ⁱ⁾+(1−α)A_{E}(j,k)⁽ⁱ⁻¹⁾

If, in addition, a planned traffic matrix T₀ predefined by the operator or a long-term empirical value is also to be taken into consideration, then the following two variants are provided for determining the elements T_{A}(j,k) of the active traffic matrix:

Variant 1 (using the maximum of the estimated and predefined values):

T_{A}(j,k)=max[T₀(j,k), A_{E}(j,k)]

Variant 2 (weighted averaging between estimated and predefined values):

TA(j,k)=γT₀(j,k)+(1−γ)A_{E}(j,k)γε[0,1]

Where γ=0, only the currently estimated value is used; where γ=1, only the predefined value is used. Other averaging functions can be easily constructed by the person skilled in the art for determining T_{A}(j,k). Similarly, other averaging functions can be simply deduced by the person skilled in the art for calculating A_{E}(j,k)⁽ⁱ⁾.

Implementations other than a central control server or network control server, which estimates the traffic matrix using data from NACs, are possible for the network shown in the FIGURE. Thus, for example, the described functions can be integrated into a network management system or into a service control facility. A distribution or replication of the functions in IP routers (for example routers i, j) or in admission control elements (for example signaling components SKj, SKk) is an alternative embodiment.

1.-10. (canceled)

11. A method for estimating the bandwidth requirements in a communications network, formed using nodes and links, with access controls, the nodes including an input node and an output node, comprising:
for a time interval:
ascertaining a first value for the average bandwidth permitted for the transportation between the input and output nodes;
ascertaining a weighted second value for the sum of the bandwidths of the declined reservation requests; and
forming an estimated value for the bandwidth requirements for traffic to be transmitted between the input node and the output node from the sum of the first value and the weighted second value.

12. The method as claimed in claim 11, wherein the weighting is performed via a weighting factor that takes into consideration the number of reservation requests declined in the time interval.

13. The method as claimed in claim 12, wherein the weighting factor is formed with an interpolation parameter lying between zero and one.

14. The method as claimed in claim 11, wherein retries of declined reservation requests are taken into consideration during determination of the second value.

15. The method as claimed in claim 11, wherein a further estimated value is formed for the current bandwidth requirements for traffic to be transmitted between the input node and the output node through interpolation of two estimated values formed for successive time intervals.

16. The method as claimed in claim 12, wherein measurement data is ascertained successively for the first value, the second value and the number of reservation request declined in overlapping time intervals.

17. The method as claimed in claim 11,
wherein a nominal value for the bandwidth requirements is given for the transmission between the input and output nodes and
wherein a value for the bandwidth requirements is formed for the transmission between the input and output nodes from the nominal value and the estimated value.

18. The method as claimed in claim 11, wherein the ascertaining a first value, the ascertaining the second value, and the forming the estimated value is performed for all node pairs, consisting of an input node and an output node, in the network.

19. A device with means in a communications network having an input node and an output node, comprising:
wherein within a time interval:
a first value for the average bandwidth permitted for the transportation between the input and output nodes is ascertained;
a weighted second value for the sum of the bandwidths of the declined reservation requests is ascertained; and
an estimated value for the bandwidth requirements for traffic to be transmitted between the input node and the output node from the sum of the first value and the weighted second value is formed.

20. The device as claimed in claim 19, the device is implemented via a control server for the network, by a part of the management system of the network, by a service control facility, by a router or by access control units.
